(19) United States
(12) Patent Application Publication
(10) Pub. No.: US 2026/0172319 A1
(43) Pub. Date: Jun. 18, 2026

(54) MOBILITY CORE AND RADIO ACCESS NETWORK LANGUAGE MODEL AGENT

(71) Applicants: AT&T Intellectual Property I, L.P., Atlanta, GA (US); AT&T Mobility II LLC, Atlanta, GA (US)

(72) Inventors: He Yan, Berkeley Heights, NJ (US); Cheuk Yiu Ip, Metuchen, NJ (US); Maulik Shah, Carrollton, TX (US); Joseph Maniaci, Saint Paul, MN (US)

(21) Appl. No.: 18/984,992

(22) Filed: Dec. 17, 2024

(51) Int. Cl. H04L 41/16; H04L 41/22

(52) U.S. Cl. CPC H04L 41/16; H04L 41/22

(57) ABSTRACT

A processing system may obtain a natural language request for a network management task in a cellular network, interpret, via a language model agent implemented by the processing system, that the natural language request pertains to at least one dynamic data component from a network status database system, and obtain, in accordance with at least one agent tool, the at least one dynamic data component. The processing system may obtain, in accordance with the at least one agent tool, at least one static data component from a cellular network documentation repository, where the at least one static data component is retrieved based upon the at least one dynamic data component, and generate, via a language model of the language model agent an output responsive to the natural language request using the at least one dynamic data component and the at least one static data component as inputs.

The present disclosure relates generally to radio access and mobility core network operations, and more specifically to methods, computer-readable media, and apparatuses for generating an output responsive to a natural language request via a language model of a language model agent using at least one dynamic data component and at least one static data component obtained in accordance with first and second agent tools.

### BACKGROUND

A large communication network may collect and process a substantial volume of data generated by devices/systems. Such data may be primarily maintained in database tables, e.g., in a structured query language (SQL) or no-SQL format. In addition, tables, or rows and columns thereof may be associated or linked to one another to maintain additional knowledge in a graph database, and so forth.

### SUMMARY

The present disclosure describes methods, computer-readable media, and apparatuses for generating an output responsive to a natural language request via a language model of a language model agent using at least one dynamic data component and at least one static data component obtained in accordance with first and second agent tools. For instance, in one example, a processing system including at least one processor may obtain a natural language request for a network management task in a cellular network, interpret, via a language model agent implemented by the processing system, that the natural language request pertains to at least one dynamic data component from a network status database system, and obtaining, in accordance with at least one agent tool, the at least one dynamic data component. The processing system may next obtain, in accordance with the at least one agent tool, at least one static data component from a cellular network documentation repository, where the at least one static data component is retrieved based upon the at least one dynamic data component. The processing system may then generate, via a language model of the language model agent an output responsive to the natural language request using the at least one dynamic data component and the at least one static data component as inputs to the language model.

### BRIEF DESCRIPTION OF THE DRAWINGS

The present disclosure can be readily understood by considering the following detailed description in conjunction with the accompanying drawings, in which:

FIG. 1 illustrates an example of a system related to the present disclosure;

FIG. 2 illustrates a flowchart of an example method for generating an output responsive to a natural language request via a language model of a language model agent using at least one dynamic data component and at least one static data component obtained in accordance with first and second agent tools; and

FIG. 3 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for generating an output responsive to a natural language request via a language model of a language model agent using at least one dynamic data component and at least one static data component obtained in accordance with at least one agent tool (e.g., one or more agent tools, first and second agent tools, etc.). In particular, examples of the present disclosure may process natural language requests for radio access network management tasks in a cellular network via a language model agent that is configured to interpret the requests, to identify static and dynamic data components to be retrieved to fulfill the requests, to identify agent tool(s) available to retrieve the static and dynamic data components, and to formulate an output, e.g., in text, visual, or other forms via a language model core of the agent using the dynamic and static data components that are retrieved. To further illustrate, examples of the present disclosure may provide a language model agent or language model-based agent, such as a large language model (LLM) agent that can perform dynamic reasoning across various documents and numerical or other categorical data sources, thereby significant improving the efficiency and accuracy of cellular network operations. Currently, designing, auditing, troubleshooting, and optimizing a cellular network is primarily rule-based (via human or automation). For instance, given an alarm, outage, or performance degradation signature, a network operator may have a set of rules to follow regarding the actionable steps for a given signature. For example, in response to a detected congestion condition, certain rules may be followed to tune the cellular network configuration settings/parameters to alleviate the congestion condition. However, such fixed sets of rules have limitations in terms of completeness and correctness over time as the network continues evolving.

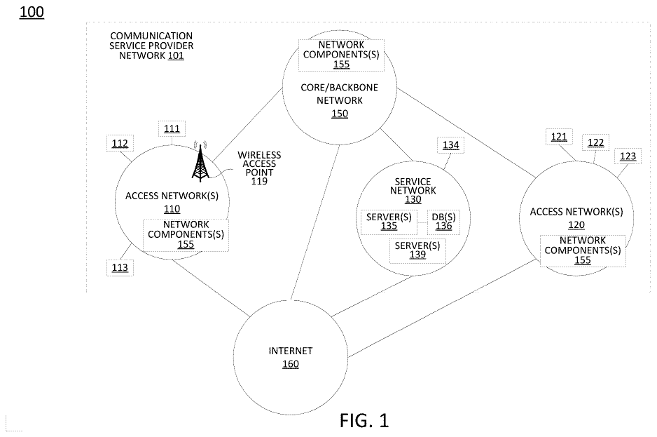

In one example, the present disclosure may fine tune a machine learning model (MLM), such as a LLM (e.g., a generative pre-trained transformer (GPT) model, or the like), to provide high-level instructions to address radio access network (RAN)/cellular network-specific issues. For instance, such an LLM may be used as a core LLM for a LLM-based agent (also referred to herein as a LLM agent or language model agent) of the present disclosure. In addition, in one example, the present disclosure may further enhance such a fine-tuned LLM to provide concrete actionable instructions, e.g., using specific agent tools. For instance, a LLM agent of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store. In one example, the LLM agent may be based on a ReACT agent framework, or other types of LLM-agent, and may be configured to perform dynamic reasoning across various documents and numerical and/or categorical data sources. In one example, the present disclosure may further provide a web-based interface, e.g., a graphical user interface (GUI), for RAN/cellular network personnel to interact with the LLM agent to submit requests, to obtain outputs, to provide user feedback to continuously improve RAG and other functionalities of the LLM agent, and so forth. In addition, in various examples, the present disclosure may be implemented using the current and/or future tools and technologies, such as using a LangChain framework with Snowflake application programming interface (API), large language model(s) (LLM(s) (such as OpenAI and others), Streamlit user interface (UI) implementation, and so forth. These and other aspects of the present disclosure are discussed in greater detail below in connection with the examples of FIGS. 1-3.

To aid in understanding the present disclosure, FIG. 1 illustrates an example system 100 comprising a plurality of different networks in which examples of the present disclosure may operate. Communication service provider network 101 may comprise a core network and/or backbone network 150 with components for telephone services, Internet services, and/or video services (e.g., triple-play services, etc.) that are provided to customers (broadly “subscribers”), and to peer networks. In one example, core/backbone network 150 may combine core network components of a cellular network with components of a triple-play service network. For example, communication service provider network 101 may functionally comprise a fixed-mobile convergence (FMC) network, e.g., an IP Multimedia Subsystem (IMS) network. In addition, core/backbone network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 101 may also further comprise a broadcast video network, e.g., a cable television provider network or an Internet Protocol Television (IPTV) network, as well as an Internet Service Provider (ISP) network. With respect to video/television service provider functions, core/backbone network 150 may include one or more video servers for the delivery of video content, e.g., a broadcast server, a cable head-end, a video-on-demand (VoD) server, and so forth. For example, core/backbone network 150 may comprise a video super hub office, a video hub office and/or a service office/central office.

In one example, access/service networks 110 and 120 may provide one or more services to subscribers and/or customer premises, such as voice, data, video, and/or wireless access services, virtual local area network (VLAN) services, and so forth. For instance, access/service networks 110 and 120 may each comprise a Digital Subscriber Line (DSL) network, a broadband cable access network, a Local Area Network (LAN), a cellular or non-cellular wireless access network, and the like. For example, access/service networks 110 and 120 may transmit and receive communications between endpoint devices 111-113, endpoint devices 121-123, and data center network 130 (broadly a service network), and between core/backbone network 150 and endpoint devices 111-113 and 121-123 relating to voice telephone calls, communications with web servers via the Internet 160, and so forth. Access/service networks 110 and 120 may also transmit and receive communications between endpoint devices 111-113, 121-123 and other networks and devices via Internet 160. In another example, one or both of the access/service networks 110 and 120 may comprise an ISP network external to communication service provider network 101, such that endpoint devices 111-113 and/or 121-123 may communicate over the Internet 160, without involvement of the communication service provider network 101. Endpoint devices 111-113 and 121-123 may each comprise customer premises equipment (CPE), user equipment (UE), and/or other endpoint device types, such as a telephone, e.g., for analog or digital telephony, a mobile device, such as a cellular smart phone, a laptop, a tablet computer, etc., a router (e.g., a customer edge (CE) router), a gateway, a desktop computer, a plurality or cluster of such devices, a television (TV), e.g., a “smart” TV, or a set-top box (STB).

In one example, the access/service networks 110 and 120 may be different types of access networks. In another example, the access/service networks 110 and 120 may be the same type of access network. In one example, one or more of the access/service networks 110 and 120 may be operated by the same or a different service provider from a service provider operating the communication service provider network 101. For example, each of the access/service networks 110 and 120 may comprise an Internet service provider (ISP) network, a cable access network, and so forth. In another example, each of the access/service networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access/service network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like. In still another example, access/service networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access/service networks 110 or 120, which receives data from and sends data to the endpoint devices 111-113 and 121-123, respectively.

In this regard, it should be noted that in some examples, endpoint devices 111-113 and 121-123 may connect to access/service networks 110 and 120 via one or more intermediate devices, such as a home or enterprise gateway and/or router, e.g., where access/service networks 110 and 120 comprise cellular access networks, ISPs and the like, while in another example, endpoint devices 111-113 and 121-123 may connect directly to access/service networks 110 and 120, e.g., where access/service networks 110 and 120 may comprise local area networks (LANs), enterprise networks, and/or home networks, and the like.

In one example, communication service provider network 101 may also include one or more network components 155 (e.g., in core/backbone network 150 and/or access/service networks 110 and 120). Network components 155 may include various physical components of communication service provider network 101. For instance, network components 155 may include various types of optical network equipment, such as an optical network terminal (ONT), an optical network unit (ONU), an optical line amplifier (OLA), a fiber distribution panel, a fiber cross connect panel, and so forth. Similarly, network components 155 may include various types of cellular network equipment, such as a mobility management entity (MME), a mobile switching center (MSC), an eNodeB, a gNB, a base station controller (BSC), a baseband unit (BBU), a remote radio head (RRH), an antenna system controller, and so forth. In one example, network components 155 may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network components 155 may further include various other types of communication network equipment such as a layer 3 router, e.g., a provider edge (PE) router, an integrated services router, etc., an Internet exchange point (IXP) switch, and so on. In one example, network components 155 may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. In addition, in one example, network component 155 may include measurement systems, such as network probe devices or the like, to test connectivity across core/backbone network 150, access/service network(s) 110, and/or access/service network(s) 120 (e.g., end-to-end and/or within a selected network segment, etc.). In addition, for ease of illustration, various components of communication service provider network 101 are omitted from FIG. 1.

Still other network components 155 may include a database of assigned telephone numbers, a database of basic customer account information for all or a portion of the customers/subscribers of the communication service provider network 150, a cellular network service home location register (HLR), e.g., with current serving base station information of various subscribers, and so forth, a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other network components 155 may include, for example, a layer 3 router, a short message service (SMS) server, a voicemail server, a video-on-demand server, a server for network traffic analysis, a database server/database system, and so forth. It should be noted that in one example, a communication network component may be hosted on a single server, while in another example, a communication network component may be hosted on multiple servers, e.g., in a distributed manner.

In accordance with the present disclosure, network components 155 may comprise “network resources” of various network resource types, which may also include services provided and/or hosted via network components 155, e.g., enterprise communication services, such as a virtual private network (VPN) service, a virtual local area network (VLAN) service, a Voice over Internet Protocol (VoIP), a software defined-wide area network (SD-WAN) service, an Ethernet wide area network E-WAN service, and so forth. Alternatively, or in addition, network resources may include interfaces or ports associated with such services, such as a customer edge (CE) router or PBX-to-time division multiplexing (TDM) gateway interface, a Border Gateway Protocol (BGP) interface (e.g., between BGP peers), and so forth. For instance, a CE router, PBX, or the like may be homed to one or several provider edge (PE) routers or other edge component(s).

In one example, the data center network 130 may comprise a local area network (LAN), or a distributed network connected through permanent virtual circuits (PVCs), virtual private networks (VPNs), and the like for providing data and voice communications. In one example, the data center network 130 may comprise one or more devices for providing services to subscribers, customers, and/or users. For example, communication service provider network 101 may provide a cloud storage service, web server hosting, and other services. As such, data center network 130 may represent aspects of communication service provider network 101 where infrastructure for supporting such services may be deployed. In one example, the data center network 130 may alternatively or additionally comprise one or more devices supporting operations and management of communication service provider network 101. For instance, in the example of FIG. 1, server(s) 139 may include higher level services/applications such as a database of assigned telephone numbers, a database of basic customer account information for all or a portion of the customers/subscribers of the communication service provider network 101, a billing system, a customer relationship management (CRM) system, a trouble ticket system, an ordering system, an enterprise reporting system (ERS), an account object (AO) database system, a network inventory system, a network topology/mapping system, a network provisioning system, a unified data repository (UDR), and so forth. In one example, server(s) 139 may alternatively or additionally comprise one or more of the types of network components 155 described above.

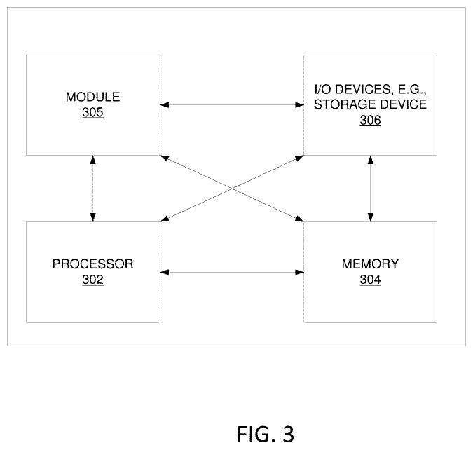

In addition, data center network 130 may include one or more servers 135 which may each comprise all or a portion of a computing device or system, such as computing system 300, and/or processing system 302 as described in connection with FIG. 3 below, specifically configured to perform various steps, functions, and/or operations for generating an output responsive to a natural language request via a language model of a language model agent using at least one dynamic data component and at least one static data component obtained in accordance with at least one agent tool (e.g., first and second agent tools), as described herein. For example, one of the server(s) 135, or a plurality of the servers 135 collectively, may perform operations in connection with the example method 200, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, data center network 130 may also include one or more databases (DBs) 136, e.g., physical storage devices integrated with server(s) 135 (e.g., database servers), attached or coupled to the server(s) 135, and/or in remote communication with server(s) 135 to store various types of information in connection with examples of the present disclosure. For example, DB(s) 136 may be configured to receive and store network topology data, including the type(s) of network resources/network elements (e.g., both physical and virtual), the locations of such network resources, the connectivity between resources, the allocation of such resources to sub-nets, tracking areas, or the like, and so forth. In one example, the network topology information/data may include or may be cross-referenced to network inventory data, such as, for physical network resources, the manufacture date, the purchase date, the deployment date, the last serviced date and/or a service history, identities of the service technician(s), an incident/event list (e.g., for past network events associated with the network resource), a serial number, a model number, a version number, a software version, and so forth. In one example, the network topology data may comprise a network graph, or network graph database. For instance, nodes in the graph/graph database may represent network resources, network zones, etc., where some links/edges may represent physical links, or logical paths over physical links, while other links/edges may represent logical relationships, such as a virtual network function (VNF) being instantiated on a particular network function virtualization infrastructure (NFVI) physical element, a network resource being a component of a particular sub-net or tracking area, etc.

In addition, DB(s) 136 may be configured to receive and store network operational data, including performance indicator data (e.g., “key performance indicators” (KPIs)), such as: utilization and/or availability levels of network resources, configuration settings and/or parameters of such network resources, alarm data, and so forth. For instance, such data may be collected from various network components 155 reporting to server(s) 135 and/or to DB(s) 136, such as routers, RAN elements, cellular core network components, video distribution components, storage servers, content distribution network nodes, etc. In this regard, it should be noted that in one example, network component(s) 115 may also include one or more aggregator devices for collecting performance data (e.g., KPIs) and/or configuration data for various network elements and/or aspects of communication service provider network 101. For instance, such aggregator device(s) may collect performance indicators and/or configuration data over a period of time, and may then provide a batch report and/or aggregated records to DB(s) 136, for instance. It should be noted that some or all of such information (network topology and/or network operational data) may be contained in other network databases/systems, such as one or more of an active and available inventory (A&AI) database, a network inventory database, a call detail records (CDR) repository, or the like (e.g., represented by server(s) 139 and/or various network components 155). Alternatively, or in addition, DB(s) 136 may be configured to receive and store customer/subscriber network resource order information (e.g., an additional type or types of network operational data), such as the subscriber/customer identities and other characteristics (e.g., a customer intensity value and/or a customer segment as described herein), the timing of such orders, the quantities of such orders, the type of service(s) ordered, and so forth. In one example, aspects of the abovementioned data may be stored in user, subscriber, and/or account profiles, which may include account owner biographic information, such as individual or entity name, address, phone number(s), device identifier(s), authorized users, age(s), service history, payment history, payment methods, communication preferences, privacy preferences, and so forth. In other words, some of the abovementioned data types may be stored in or linked to respective user/account profiles, or the like. Similar to the above, some or all of such information may be contained in other network databases/systems, such as one or more of an authentication, authorization, and accounting (AAA) server/system, an operations support system (OSS), a business support system (BSS), a unified data repository (UDR), or the like.

It should be noted that in accordance with the present disclosure, the network topology information/data and/or network operational data stored in DB(s) 136 or elsewhere may be maintained over a period of time. For instance, DB(s) 136 may store respective time series data indicative of different states of a network topology, different utilization and/or assignment levels of various network resources of various types in a given time interval (and over a period of a plurality of time intervals), etc. In one example, data may be segregated by customer segment, network zone, geographic region, and so forth.

In one example, DB(s) 136 may alternatively or additionally receive and store data from one or more external data feeds. For instance, DB(s) 136 may receive and store geographic data, e.g., from one or more external services, such as a geographic information system (GIS), which may include digital map data such as geo-political boundary maps, terrain maps, and so forth. Alternatively, or in addition, DB(s) 136 may receive and store weather data from a device of a third-party, e.g., a weather service, a traffic management service, etc. via one of the access/service networks 110 or 120. To illustrate, one of the endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties, which can then be correlated to network traffic data to reflect impact of various weather conditions on overall network traffic. In still another example, one of the endpoint devices 111-113 or 121-123 may represent a server of a traffic management service (e.g., for vehicular traffic) and may forward various traffic related data to DB(s) 136, such as toll payment data, records of traffic volume estimates, traffic signal timing information, and so forth. Similarly, one of the endpoint devices 111-113 or 121-123 may represent a server of an entertainment event notification service (e.g., a Really Simple Syndication (RSS) feed or the like). In such an example, DB(s) 136 may obtain one or more data sets/data feeds comprising information such as: notifications of mass sporting events, concerts, parades, civic gatherings, etc., including location information, time and duration information, expected attendance, and so forth.

In one example, DB(s) 136 may also store artificial intelligence (AI) models and/or machine learning models (MLMs) that may be trained by, activated, and/or deployed by server(s) 135 in connection with examples of the present disclosure. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In one example, the one or more of the servers 135 and/or server(s) 135 in conjunction with DB(s) 136 may comprise a generative MLM-based communication network knowledge platform (e.g., a network-based and/or cloud-based service hosted on the hardware of server(s) 135 and/or DB(s) 136).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like). In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data. In one example, MLMs of the present disclosure may include an ML-based generative model, such as a language model, e.g., a “large language model” (LLM). For instance, an ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In one example, language models of the present disclosure may comprise an ada text embedding model.

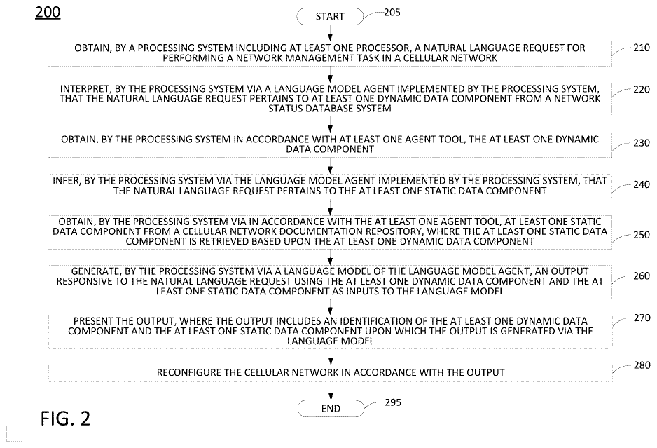

As noted above, server(s) 135 may be configured to perform various steps, functions, and/or operations for generating an output responsive to a natural language request via a language model of a language model agent using at least one dynamic data component and at least one static data component obtained in accordance with at least one agent tool (e.g., first and second agent tools), as described herein. For instance, an example method for generating an output responsive to a natural language request via a language model of a language model agent using at least one dynamic data component and at least one static data component obtained in accordance with at least one agent tool (e.g., first and second agent tools) is illustrated in FIG. 2 and described in greater detail below. For example, server(s) 135 may comprise a generative MLM-based communication network knowledge platform that may be used by network personnel for network operations and management, network troubleshooting and maintenance, network planning, and other RAN management tasks.

To further illustrate, server(s) 135 may comprise a language model agent or language model-based agent, e.g., a LLM agent. In one example, the language model agent, e.g., server(s) 135, may comprise a language model core, e.g., comprising a LLM or the like. Server(s) 135 may further include a planning module, a memory module, and a plurality of agent tools, or agent tool interfaces (e.g., application programming interfaces (APIs), webhooks, or the like) to call/interact with various tools. For example, agent tools may include a calculator, a database search tool, a graphing/visualization tool, a retrieval augmented generation (RAG)/vector database search/retrieval tool, and so forth. Accordingly, server(s) 135 may receive a natural language request for performing a cellular network management task, e.g., from one of the endpoint devices 111-113 or 121-123 (e.g., an endpoint device of a RAN engineer or other network personnel) and may interpret the request to determine dynamic and static data components that may be relevant to fulfilling the request. In addition, server(s) 135 may identify at least one agent tool (e.g., one or more agent tools) that may be used to access the dynamic and static data components. For instance, this functionality may be represented by a planning module of a language model agent. Notably, server(s) 135 may decompose a fulfillment of a natural language request performing a cellular network management task into a sequence of one or more sub-tasks (e.g., to be performed sequentially and/or in parallel). In one example, server(s) 135 may maintain a state of a task flow, e.g., as the one or more sub-tasks are processed and completed. In one example, the state of the sequence/task flow as well as intermediate data, such as dynamic and static data components retrieved at respective sub-tasks, may be stored in the memory unit of the server(s) 135. In one example, the planning module may include one or more templates that may be used to pass the request, or aspects of the request to the language model core, e.g., to determine whether dynamic and/or static data components should be retrieved, and the agent tool(s) to use to obtain these data components.

In one example, the determination to use the first and second agent tools to retrieve the at least one dynamic data component and the at least one static data component may be made at the same time, e.g., in a single effort. However, in another example, the dynamic data component(s) may be retrieved first and then it may be determined that static data component(s) is/are further needed to completely fulfill the user request based on the retrieved dynamic data component, in which case, in one example, the language model core may again be called to determine whether retrieval of the static data component(s) is warranted, and if so, which agent tool to use to obtain the static data, the call(s)/instruction(s) to be used to request the static data, etc. For instance, the second agent tool may comprise a database search tool, where the language model core may determine that one or more static data components are to be requested from a database, and may further determine a database query (e.g., an SQL query, a Gremlin query, etc.) to use to retrieve the static data component(s).

For instance, the natural language request for the cellular network management task may comprise a request for available commands to configure at least one aspect of the cellular network, where an output may comprise the available command(s). This task may involve the language model agent first determining the relevant portion of the cellular network, e.g., base station equipment in a tracking area, core NFs associated with a particular network slice, etc. For instance, this may include querying a network topology database to identify the relevant network elements and/or network functions. A next sub-task may include querying a network status database to determine a current state of this portion of the network, e.g., the current configurations (e.g., current configuration setting values) and/or current network performance indicators (e.g., indicating current load, utilization, and/or availability levels of NFs and/or components thereof (e.g., current processor capacity, memory capacity, etc.), bandwidth availability and/or utilization, alarm data, etc.). Then, given the current state of the network (or at least the portion thereof), different commands may be available. For instance, if a gNB is in a sleep mode or other modes (e.g., a power saving state, a reduced function mode, etc.) in which antennas are off, it may not be a valid command to reduce the number of antennas in use for power saving. However, valid commands may include a command to change the power state (e.g., to a lower power state or to a higher power state).

In one example, different language models may be used in the language model core to perform sub-tasks. For instance, a first language model may be used to determine that a first agent tool is to be used to obtain at least one dynamic data component and that a second agent tool is to be used to obtain at least one static data component. A different language model may be used to determine how to handle an output after gathering the at least one dynamic data component and the at least one static data component. It should also be noted that in some cases, an agent tool may also comprise a machine learning model that is different from the language model core. For instance, to retrieve data from a database, an SQL query may be used, where an agent tool may be tasked with formulating a proper SQL query, e.g., given an input of a natural language request or a high level intent for retrieval of data having particular characteristics as indicated in the natural language request or intent. However, in another example, the prompt from the planning module to the language model core may include sufficient information about the agent tool (e.g., detailed information about a database query API) such that the language model core may determine that the use of the database query agent tool is warranted and such that the language model core may also formulate the query itself.

Likewise, if a natural language request involves generating a visualization (e.g., of KPI values of a network function over a period of time, or the like), the language model core may determine to use a visualization agent tool and may generate the instructions to the visualization agent tool. However, in another example, the visualization agent tool may comprise an MLM that is specifically trained/configured to generate instructions for a visualization platform to render visualizations. In such case, the language model core may determine that the use of the visualization agent tool is warranted, but may pass information stored in the memory module (e.g., the at least one dynamic data component and the at least one static data component, along with the original request and/or an aspects thereof) to the visualization agent tool. Then, a MLM of the visualization agent tool may parse the request and the available dynamic and static data components to generate the visualization instructions for the visualization platform to create the requested visualization. It should be noted that servers(s) 135 may alternatively or additionally perform various operations as described in connection with FIG. 2, or elsewhere herein.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of the server(s) 135 and DB(s) 136 may be distributed at different locations, such as in or connected to access/service networks 110 and 120, in another service network connected to Internet 160 (e.g., a cloud computing provider), in core/backbone network 150, and so forth. Thus, these and other modifications are all contemplated within the scope of the present disclosure.

FIG. 2 illustrates a flowchart of an example method 200 for generating an output responsive to a natural language request via a language model of a language model agent using at least one dynamic data component and at least one static data component obtained in accordance with at least one agent tool (e.g., first and second agent tools). In one example, steps, functions, and/or operations of the method 200 may be performed by a device as illustrated in FIG. 1, e.g., one or more of the servers 135, or the like, such as a language model agent. Alternatively, or in addition, the steps, functions and/or operations of the method 200 may be performed by a processing system collectively comprising a plurality of devices as illustrated in FIG. 1 such as one or more of the servers 135, DB(s) 136, endpoint devices 111-113 and/or 121-123 (e.g., user equipment (UE), or the like), and so forth. In one example, the steps, functions, or operations of method 200 may be performed by a computing device or system 300, and/or a processing system 302 as described in connection with FIG. 3 below. For instance, the computing device 300 may represent at least a portion of a platform, a server, a system, and so forth, in accordance with the present disclosure. For illustrative purposes, the method 200 is described in greater detail below in connection with an example performed by a processing system. The method 200 begins in step 205 and proceeds to step 210.

At step 210, the processing system obtains a natural language (NL) request for performing a network management task in a cellular network. For instance, the NL request may be a request to map a parameter for a first type of vendor equipment to a closest parameter for a second type of vendor equipment. For example, a RAN engineer may be knowledgeable in deploying and managing equipment from a first vendor, but may be correspondingly unfamiliar with network equipment of a second vendor, even if for the same type of network element, or network function. Thus, while the RAN engineer may have a general idea of a task to be performed, the RAN engineer may be unable to actually initiate and complete the task without substantial training, research, etc. As another example, the NL request may be a request for providing a visualization associated with a state of at least a portion of the cellular network, such as a request for a graph of a distribution of values for at least one network performance indicator and/or configuration setting values, a network topology visualization (e.g., a physical or logical network map), etc. In another example, the NL request may be a request for obtaining available commands to configure at least one aspect of the cellular network. In still another example, the NL request may be a request for obtaining a recommended network configuration for at least a portion of the cellular network.

At step 220, the processing system interprets, via a language model agent implemented by the processing system that the request pertains to at least one dynamic data component from a network status database system. For instance, as discussed above, the language model agent may comprise a LLM agent. Accordingly, in one example, the language model agent may include a language model, e.g., a LLM as a core module of the language model agent. In one example, the language model may comprise a generative pre-trained transformer (GPT) model. In other examples, the language model may comprise LLaMA model, a LaMDA model, a PaLM model, a BERT model, and so forth. In one example, the interpreting may be via the language model of the language model agent. For instance, in one example, step 220 may further include applying the request to the language model via a template that includes information about one or more available agent tools, the one or more available agent tools including the first agent tool. To further illustrate, in such an example, the interpreting may include determining that the first agent tool is to be used to obtain the at least one dynamic data component. For example, a template (e.g., a “prompt template”) may be: “You are asked to handle the following request: (details of the request). Determine whether additional information is needed from a network status database. You have a database search tool available.” In one example, a retrieval augmented generation (RAG) enhancement may also be provided in connection with the submission of the request/template. For instance, information on the database schema, the available tables, columns and/or data types, rows, etc. may be appended as supplemental input(s)/supplemental prompt content. In another example, a different template may be: “You are asked to handle the following request: (details of the request). You have the following tools available: a calculator, a database search tool, a graphing/visualization tool, and a RAG/vector database search/retrieval tool.” In one example, from this request template, the language model may determine a first sub-task or a sequence of sub-tasks, e.g., the first of which may be to access dynamic data from a network status database system, e.g., at least one dynamic data component. For instance, step 220 may include determining that the at least one dynamic data component should be retrieved, e.g., without knowing the particulars of such content. In addition, step 220 may include identifying the first agent tool that should be used to access/retrieve the at least one dynamic data component. In one example, step 220 may further include generating an instruction/command to cause the at least one dynamic data component to be retrieved via the first agent tool.

In various examples, other templates (e.g., “prompt templates”) of a same or similar nature may be used. In one example, the template(s) may define a set of available network management task types that may be determined. In one example, each of the available network management task types may have an associated task flow (e.g., with one or more sub-tasks, some or all of which may include the invocation of associated agent tools). In one example, the task flows may be included, e.g., as RAG/supplemental input(s)/supplemental prompt content along with the original request. Alternatively, or in addition, a task flow for a network management task type may be available in a catalog of network management task flows, which may be retrieved via a dedicated agent tool after the language model having determined the network management task type in response to the initial prompt. For instance, the first sub-task determined by the language model may be to identify the network management task type. The second sub-task may be to retrieve the task flow. The third sub-task may be to obtain dynamic data content in accordance with the task flow (e.g., per step 230 as described below, etc.).

At step 230, the processing system obtains, in accordance with at least one agent tool (e.g., a first agent tool), the at least one dynamic data component. For instance, as noted above, step 220 may include generating an instruction/command to cause the at least one dynamic data component to be retrieved via the first agent tool. For instance, the first agent tool may comprise a database query tool. As such, the instruction/command may comprise a database query that is tailored to the retrieval of the at least one dynamic data component, e.g., depending on the data types, the location(s) of the data, etc. For instance, the command/instruction may comprise a SQL query, a graph database query, e.g., a GraphDB query, a Gremlin query, etc. In one example, step 230 may include the application of the command/instruction (e.g., one or more database queries) via one or more APIs, webhooks, or the like, e.g., depending on the particulars of the database, or databases in which the data is stored. In one example, the language model of the language model agent may formulate the command/instruction (e.g., the database query/queries). However, in another example, the language model may determine that the retrieving of the at least one dynamic data component is warranted, and may determine the first agent tool that should be used to do so. Then the processing system may provide the request (or a portion of the request) to the agent tool, e.g., to formulate and execute one or more database queries, and to retrieve the at least one dynamic data component as a result/output. For instance, the first agent tool may comprise a database query generation tool. In particular, the first agent tool may be another MLM that may be more specifically trained for the focused task of generating SQL queries, generating graph DB queries, or the like.

In any case, step 230 may result in the retrieval of the at least one dynamic data component from the network status database system, e.g., from one or more databases thereof. For instance, in various examples, the at least one dynamic data component may comprise: one or more network performance indicator values (e.g., one or more KPI values), one or more configuration values for one or more network configuration settings (e.g., for one or more NFs, including interfaces between/supported by the NFs, such as link bandwidth regulated by the respective NFs on a link, etc.), current network topology information of the cellular network (e.g., including RAN and/or cellular core), and so forth. It should be noted that the current network topology information may relate to a particular physical or logical portion of the cellular network that may be relevant to the request, such as a geographic region, a tracking area, a network slice, etc. In addition, the network performance indicator values may be for a same type of KPI over time, or multiple KPIs over one or multiple time slots, and so on. In general, the at least one dynamic data component may relate to a state of the cellular network at any one or several instances in time.

At optional step 240, the processing system may infer, via the language model agent implemented by the processing system, that the request pertains to the at least one static data component. For instance, optional step 240 may include applying at least a portion of the request to the language model via a template that includes: (1) information about one or more available agent tools, the one or more available agent tools including the second agent tool; and (2) the at least one dynamic data component. In one example, the template may further include the request or a portion thereof. For instance, the language model agent may parse the request at step 220 and may identify that certain portions of the request are not relevant to the sub-task(s) of identifying that one or more static data components should be retrieved and/or the retrieval of the static data component(s). For example, a portion of the request may specify a preference for a type of output, such as a visualization. Such a part of the NL request may therefore be truncated prior to use as an input at optional step 240. In one example, optional step 240 may include an additional call to the language model of the language model agent to generate the inference.

At step 250, the processing system obtains, in accordance with the at least one agent tool (e.g., a second agent tool, where the second agent tool is distinct from the first agent tool or where the second agent tool is the same as the first agent tool), at least one static data component from a cellular network documentation repository, where the at least one static data component is retrieved based upon the at least one dynamic data component. In one example, step 250 may be performed in response to the inferring of optional step 240. In various examples, the at least one static data component may include one or more of: subscriber service documentation, cellular technology standards documentation (e.g., 3GPP technical standards or the like), cellular network operator documentation (e.g., procedures, manuals, best practices, whitepapers, etc.), at least one cellular network-related law or regulation, or the like. For example, the set of available laws and regulations can be previously specified by a system operator in advance, from which the processing system may obtain those that are even more relevant to the request. In other words, where relevant laws or regulations are to be retrieved, the search is not over the entirety of US federal and state statutes, Code of Federal Regulations, and state and local regulations, etc. Rather, the set of laws and regulations may be initially bounded by placing those that are deemed relevant to cellular network technologies in a database of selected laws and regulations, from which it may be narrowed down by the processing system in accordance with the language model agent and the second agent tool based on the particular NL request (and more specifically based on the at least one dynamic data component that is retrieved at the prior step 230). For example, the dynamic data components may indicate substantial alarm data for a relevant portion of the cellular network. In such case, the types of documents and their contents that may be relevant will be different depending on whether one or more alarm indicators are present in the dynamic data component(s), the type(s) of alarm(s), and so forth.

In one example, the second agent tool may comprise a search engine (e.g., implemented by the processing system or accessible to the processing system via an agent tool interface (e.g., an API, webhook(s), etc.) that matches documents to an input vector comprising: the request (or a portion of the request) and the at least one dynamic data component that may be input. Accordingly, in one example, the second agent tool may comprise yet another MLM that is more specifically configured/trained for this sub-task. For example, the search engine may use a term frequency-inverse document frequency term search for matching terms that exist in the NL request, or terms that are associated with terms in the NL request to terms that are contained in respective documents in the document repository (or similar search algorithm). In one example, the search may be further based upon additional context, such as the identity or type of the user/client submitting the NL request. In one example, the second agent tool (e.g., another MLM) may be trained on an ongoing basis using feedback of the accuracy of the search results in response to different inputs (e.g., from labels/feedback provided by RAN engineers or other network personnel). In one example, the processing system may obtain the top “N” number of documents that may be relevant to the NL request and to the dynamic data component(s) that is/are obtained at step 230.

At step 260, the processing system generates, via the language model of the language model agent, an output responsive to the request using the at least one dynamic data component and the at least one static data component as inputs to the language model. For instance, when the NL request comprises a request for a recommended network configuration, the output may comprise the recommended network configuration as determined by the language model in accordance with both the dynamic data component(s) and the static data component(s). For example, the recommended network configuration may comprise a set of: one or more network functions and/or one or more configuration setting values for the one or more network functions. The recommended network configuration may further include links between two or more network functions (where the one or more network functions may comprise the two or more network functions), link bandwidth (which could be part of configuration setting values or which could be independently specified in one example), and so forth. Similarly, when the NL request comprises a request to map a parameter for a first type of vendor equipment to a closest parameter for a second type of vendor equipment, the output may comprise the closest parameter for the second type of vendor equipment as determined by the language model in accordance with the dynamic data component(s) and the static data component(s). Likewise, when the NL request comprises a request for a visualization associated with a state of at least a portion of the cellular network, the output may comprise the visualization.

In one example, step 260 may be invoked by the processing system via the language model agent using yet another template for the input/prompt to the language model. For instance, the processing system (e.g., via the language model agent thereof) may maintain/track a state of a task flow for a set of sub-tasks determined for processing the particular NL request from start to finish. Thus, for instance, a template for step 260 may include “You have been asked to (details of the request). Relevant dynamic data component(s) have already been retrieved from the network status database system and are attached. Relevant static data component(s) have already been retrieved and are also attached.” Other templates of a same or similar nature may be used in various examples. In one example, these templates may be particularized to different defined NL request types, such as discussed above.

It should also be noted that in an example in which the NL request comprises a request for a visualization associated with a state of at least a portion of the cellular network, to generate the output visualization, in one example, the language model agent and/or the language model thereof may determine that still another agent tool should be invoked, e.g., a graphing/visualization tool for generating data visualizations. For example, the graphing/visualization agent tool may comprise still another machine learning model (e.g., a generative model) that is configured to generate instructions in accordance with a network data visualization platform. For instance, the network data visualization platform may include a catalog of: a plurality of available types of network data visualizations and a plurality of configurable parameters for the plurality of available types of network data visualizations, such as a selectable zoom level, a selectable number of hops from one or more network resources to include in the visualization, an option to include or omit geographic element(s)/layer(s), road map element(s)/layer(s), etc., time periods to be included, and so forth. Thus, the processing system, via the language model agent, may infer intents from the NL request and may output visualization generation instructions to the graphing/visualization agent tool in accordance with the intents. Alternatively, the graphing/visualization agent tool may obtain the NL request and may generate the respective instructions for the network data visualization platform. In addition, the dynamic data component(s) and/or the static data component(s) may comprise additional inputs that may inform the type of visualization, the contents/data of the visualization, and so forth. In one example, step 260 may include retrieval augmented generation (RAG) so as to include additional inputs to the graphing/visualization agent tool, such as an instruction manual for the network data visualization platform, API information, examples of instruction syntax, or the like. Thus, in one example, the language model may output an instruction to cause the network data visualization platform to generate the requested visualization (where in one example, the processing system may include the network data visualization platform).

At optional step 270, the processing system may present the output, e.g., where the output includes an identification of the at least one dynamic data component and an identification of the at least one static data component upon which the output is generated via the language model. In one example, the output may be presented via a client GUI associated with the language model agent. For instance, the output may be presented in a text format, such as a description of a closest parameter for the second type of vendor equipment that is mapped to a parameter for a first type of vendor equipment, a description of a recommended network configuration, a description of available commands, etc. In an example in which the output may comprise a visualization, optional step 270 may comprise transmitting and/or rendering the visualization for display on a screen, e.g., at a client device of a user submitting the NL request. It should be noted that the identification of the at least one dynamic data component and the identification of the at least one static data component may provide assurance to the RAN engineer or other users submitting the NL request that the output is grounded in reality, i.e., with the particular sources of the at least one dynamic data component and the at least one static data component being identified so that these sources can be independently verified, if necessary. In particular, this information provides the opportunity to verify that the language model core did not hallucinate the results.

At optional step 280, the processing system may reconfigure the cellular network in accordance with the output. For instance, in one example, the agent tools may further include a service and management orchestrator (SMO) and/or RAN intelligent controller (RIC) interface tool that may enable the language model agent to implement a recommended network configuration. In one example, optional step 280 may include obtaining an authorization/input from a client device (e.g., from a user) authorizing the implementation of the network configuration, e.g., in response to a presentation of the recommended network configuration at optional step 270.

Following step 260 and/or either or both of optional steps 270-280, the method 200 ends in step 295.

It should be noted that method 200 may be expanded to include additional steps, or may be modified to replace steps with different steps, to combine steps, to omit steps, to perform steps in a different order, and so forth. For instance, in one example, the processing system may repeat one or more steps of the method 200, such as steps 210-260 or 210-280 for new NL request(s). In one example, the method 200 may include providing suggested NL requests/prompts prior to obtaining the NL request at step 210. In one example, the method 200 may include storing NL requests along with the corresponding outputs for fast re-access. In one example, the method 200 may include obtaining feedback and retraining the core language model of the language model agent and/or one or more MLMs that may comprise or may be associated with one of the agent tools. Alternatively, or in addition, the method 200 may include other pre-or post-processing operations, such as ETL operations, data cleansing, sanitizing, averaging, etc. In one example, optional step 240 may be subsumed by step 220. For instance, the identification of the desirability of obtaining the dynamic data component(s) and the static data component(s) may be determined at the same time and/or in a single pass, e.g., instead of a two-step process of first obtaining the dynamic data component(s) and then determining a desirability of obtaining the particular static data component(s). In one example, the method 200 may be expanded or modified to include steps, functions, and/or operations, or other features described above in connection with the example(s) of FIG. 1, or as described elsewhere herein. Thus, these and other modifications are all contemplated within the scope of the present disclosure.

In addition, although not specifically specified, one or more steps, functions, or operations of the method 200 may include a storing, displaying, and/or outputting step as required for a particular application. In other words, any data, records, fields, and/or intermediate results discussed in the method 200 can be stored, displayed and/or outputted either on the device executing the method 400, or to another device, as required for a particular application. Furthermore, steps, blocks, functions, or operations in FIG. 2 that recite a determining operation or involve a decision do not necessarily require that both branches of the determining operation be practiced. In other words, one of the branches of the determining operation can be deemed as an optional step. In addition, one or more steps, blocks, functions, or operations of the above described method 200 may comprise optional steps, or can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1 or described in connection with the example(s) of FIG. 2 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for generating an output responsive to a natural language request via a language model of a language model agent using at least one dynamic data component and at least one static data component obtained in accordance with first and second agent tools, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 3, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 3 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for generating an output responsive to a natural language request via a language model of a language model agent using at least one dynamic data component and at least one static data component obtained in accordance with first and second agent tools (e.g., a software program comprising computer-executable instructions) can be loaded into memory 304 and executed by hardware processor element 302 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for generating an output responsive to a natural language request via a language model of a language model agent using at least one dynamic data component and at least one static data component obtained in accordance with first and second agent tools (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, a natural language request for performing a network management task in a cellular network;
interpreting, by the processing system via a language model agent implemented by the processing system, that the natural language request pertains to at least one dynamic data component from a network status database system;
obtaining, by the processing system in accordance with at least one agent tool, the at least one dynamic data component;
obtaining, by the processing system in accordance with the least one agent tool, at least one static data component from a cellular network documentation repository, where the at least one static data component is retrieved based upon the at least one dynamic data component; and
generating, by the processing system via a language model of the language model agent an output responsive to the natural language request using the at least one dynamic data component and the at least one static data component as inputs to the language model.

2. The method of claim 1, further comprising:
presenting the output, wherein the output includes an identification of the at least one dynamic data component and the at least one static data component upon which the output is generated via the language model.

3. The method of claim 1, wherein the at least one dynamic data component comprises at least one of:
at least one network performance indicator value;
at least one configuration value for one or more network configuration settings; or
network topology information of the cellular network.

4. The method of claim 1, wherein the at least one static data component comprises at least one of:
subscriber service documentation;
cellular technology standards documentation;
cellular network operator documentation; or
at least one cellular network-related law or regulation.

5. The method of claim 1, wherein the natural language request for performing the network management task comprises a request to map a parameter for a first type of vendor equipment to a closest parameter for a second type of vendor equipment, wherein the output comprises the closest parameter for the second type of vendor equipment.

6. The method of claim 1, wherein the natural language request for performing the network management task comprises a request for a visualization associated with a state of at least a portion of the cellular network, wherein the output comprises the visualization.

7. The method of claim 6, wherein the generating of the output comprises using the at least one agent tool for generating data visualizations.

8. The method of claim 1, wherein the natural language request for performing the network management task comprises a request for a recommended network configuration, wherein the output comprises the recommended network configuration, wherein the recommended network configuration comprises a set of:
one or more network functions; or
one or more configuration setting values for the one or more network functions.

9. The method of claim 1, wherein the natural language request for performing the network management task comprises a request for available commands to configure at least one aspect of the cellular network, wherein the output comprises the available commands.

10. The method of claim 1, wherein the language model comprises a large language model.

11. The method of claim 10, wherein the language model comprises a generative pre-trained transformer model.

12. The method of claim 1, wherein the language model agent comprises a large language model agent.

13. The method of claim 1, wherein the at least one agent tool comprises a database query tool for obtaining the at least one dynamic data component.

14. The method of claim 13, wherein the at least one agent tool further comprises a document search engine tool for obtaining the at least one static data component.

15. The method of claim 1, wherein the interpreting is via the language model of the language model agent.

16. The method of claim 1, wherein the interpreting comprises:
determining that the at least one agent tool is to be used to obtain the at least one dynamic data component.

17. The method of claim 1, further comprising:
inferring, by the processing system via the language model agent, that the natural language request pertains to the at least one static data component.

18. The method of claim 17, wherein the inferring comprises determining that the at least one agent tool is to be used to obtain the at least one static data component.

19. A non-transitory computer-readable medium storing instructions which, when executed by a processing system including at least one processor, cause the processing system to perform operations, the operations comprising:
obtaining a natural language request for a network management task in a cellular network;
interpreting, via a language model agent implemented by the processing system, that the natural language request pertains to at least one dynamic data component from a network status database system;
obtaining, in accordance with at least one agent tool, the at least one dynamic data component;
obtaining, in accordance with the at least one agent tool, at least one static data component from a cellular network documentation repository, where the at least one static data component is retrieved based upon the at least one dynamic data component; and
generating, via a language model of the language model agent an output responsive to the natural language request using the at least one dynamic data component and the at least one static data component as inputs to the language model.

20. An apparatus comprising:
a processing system including at least one processor; and
a computer-readable medium storing instructions which, when executed by the processing system, cause the processing system to perform operations, the operations comprising:
obtaining a natural language request for a network management task in a cellular network;
interpreting, via a language model agent implemented by the processing system, that the natural language request pertains to at least one dynamic data component from a network status database system;
obtaining, in accordance with at least one agent tool, the at least one dynamic data component;
obtaining, in accordance with the at least one agent tool, at least one static data component from a cellular network documentation repository, where the at least one static data component is retrieved based upon the at least one dynamic data component; and
generating, via a language model of the language model agent an output responsive to the natural language request using the at least one dynamic data component and the at least one static data component as inputs to the language model.
